(19) United States
(12) Patent Application Publication
(10) Pub. No.: US 2007/0011122 A1
(43) Pub. Date: Jan. 11, 2007

(54) Method for simulation of human response to stimulus

(76) Inventors: Douglas B. Hall, Newtown, OH (US); Jeffrey A. Stamp, Loveland, OH (US); Christopher R. Stormann, Cincinnati, OH (US)

Correspondence Address: FROST BROWN TODD, LLC, 2200 PNC CENTER, 201 E. FIFTH STREET, CINCINNATI, OH, 45202, US

(21) Appl. No.: 11/408,449

(22) Filed: Apr. 21, 2006

Related U.S. Application Data
(63) Continuation of application No. 10/314,084, filed on Dec. 6, 2002, now abandoned.
Application No. 10/314,084 is a continuation of application No. 09/492,588, filed on Jan. 27, 2000, now abandoned.
(60) Provisional application No. 60/117,413, filed on Jan. 27, 1999.

(51) Int. Cl. G06F 15/18

(52) U.S. Cl. 706/21

(57) ABSTRACT

A method is provided for simulating customer reaction to stimulus based on historical observable customer outcomes. Embodiments of the invention describe a series of steps that when taken together accomplish a predictive outcome of customer simulation from a plurality of source inputs without prior assumptions of relationship between inputs and simulated outcomes. The invention comprises a series of steps that effect the framing of the simulation model from which customer predicted outcomes are made. The various frames required to create the preferred simulation model include: customer database development, stimulus archetype development, model data development, model building, simulation of future customer reaction and suggested courses of action based on the results of the simulation.

This application claims priority to U.S. patent application Ser. No. 10/314,084, filed Dec. 6, 2002, which is a continuation of U.S. patent application Ser. No. 09/492,588, filed Jan. 27, 2000. This application further claims priority benefit of U.S. provisional application 60/117,413, filed Jan. 27, 1999.

### TECHNICAL FIELD

This invention relates to methods for predicting an individual or group reaction to a stimulus, and, more particularly, to methods utilizing models incorporating historical observations and reactions to stimuli to simulate and predict an individual or group reaction to a product, service or other concept.

### BACKGROUND OF THE INVENTION

Consumer reaction (as that term is defined in its broadest sense) to concepts, products and ideas influences many facets of our lives. For example, effective management in politics, education or the corporate world all depend on the manner in which a message is received and reacted to by a consumer or customer. The most obvious application of this point is in the development of new products or services.

In today's highly competitive global economy, a company which can successfully predict which products and services are likely to succeed in the marketplace possesses an important competitive advantage. For example, it has been estimated that the profits from the sale of a product will be significantly decreased if a company brings a product to market six months late while, on the other hand, a timely product introduction, even if significantly over budget will not result in the same magnitude of lost profits. Similarly, it has been proposed that a reduction in the lead time to product introduction can be an effective means to increase the profitability of a new product, service or concept. The exact consequences of tardy product introductions vary from one product category to the next, but rarely will tardiness be beneficial.

As a result, the evaluation of new products and services (generally referred to as product research) can be extremely important in reducing the failure rates of new products. Properly conducted product research relating to the desirability of a new product, service, or concept can be a major factor in the successful launch of such a product or service. As such, the importance of efficient, cost-effective, and reliable product or service research, especially in the developmental phases, can result in an earlier and more successful product or service introduction. Unfortunately, too many new product failures result from insufficient or careless new product research during the development stages.

Many methods are described in the art for collecting and measuring customer evaluations of consumable products or services. Several of these methods are designed to judge, rank, or predict how new or existing products will perform in the customer marketplace. Most of these methods require some type of interaction with the customer followed by the collection and measurement of customer responses based on the presented product. For example, customers can be given a sample of a product to try according to predetermined usage instructions. Subsequently, customer reaction may be gauged to determine the overall satisfaction or acceptance of one or more of the features of the product. In other cases, a pool of customers can be recruited to a central location and be shown a product in concept form as either a written summary or with graphical representation of the product. Customers are then asked to provide their impressions or judgements. As is desirable, these judgments may be related to each customer's intent to purchase or use the product.

In most methods known in the art of collecting and measuring customer evaluations of consumable products or services, the customer is shown some form of the product or service. In the case of the earliest stages of the product development cycle, this form is described as a “concept.” A concept may be simple, as in the case of a written description, or as elaborate as a finished advertisement complete with graphical image. In other cases, a short video clip, or commercial may serve as a concept. In yet other cases, the concept may be verbally communicated by a moderator who asks the customer a set of qualitative or quantitative questions related to the concept. In all of these cases, the concept forms a stimulus to which the customer reacts and elicits a response. In most cases, the customer response is a hedonic attribute that aids the product or service developer with information relating to the set of features or attributes most desired by the customer of choice. For example, customers watching proposed endings to a feature length motion picture under development may be asked to rate their likelihood of paying to see the motion picture. Similarly, prospective customers may be asked to rate their likelihood of purchasing a new type of soft drink. In both cases, it is desirable to measure the reaction of these customers to the provided concept stimulus.

Focus groups, wherein a group of individuals are polled to arrive at a common consensus regarding a new product or service, have been useful to predict the likely success of a new product or service. In a focus group setting, customers may discuss or offer impressions about their perceived utility or usefulness of the product or service shown. However, focus groups are hindered by expense and the administrative costs of implementation. Further, focus groups may be subject to misdirection or bias caused by an outspoken participant or by the focus group moderator.

Another form of new product research relies on the utilization of sample surveys. However, sample surveys regarding new products, services or concepts may be plagued by communication problems, recording errors and coding errors. Also, they are frequently quite expensive to administer. Typically, a separate focus group or sample survey must be implemented for evaluation of each new product or service. Clearly, it would be highly desirable to provide a method capable of utilizing a model that can access the cumulative learning of previous customer responses. Such a model would provide a means for future prediction of consumer response without the requirement of the time, cost, and effort to gather customer reaction to the concept under development.

Aside from the time and cost involved, there are a number of additional problems seen with standard market research techniques. Standard market research models tend to be retrospective, rather than prospective. Another key disadvantage associated with prior art systems is that most known methods require that any model for assessing a proposed product's success be derived from customer information related to the same or very similar types of products. For example, to make predictions about a snack product's success with customers, data for other snack products must first be collected before the new product is shown to customers and compared to the historical data. An example of a conventional market research system is described in U.S. Pat. No. 5,124,911, Sack, issued Jun. 23, 1992, which discloses a method where multi-attributes of a specific product or products from the same class are gathered from consumers and predictions are made based on the consumer response to a new product concept for the same class. This and similar methods often yield considerable customer or product data that is stored and unused in future product activities. For example, if a product outside the snack category is developed, say a new soft drink, conventional wisdom would be that a new database of customer reactions, including historical soft drink data, would be required to test that new product. Clearly a need exists for a method of simulating and predicting concept acceptance that may be based on data from other unrelated types of products and concepts to minimize the testing time and associated costs described above.

Still another key disadvantage of the prior art systems results from the significant costs and time required to access and test enough customers to make valid predictions for a class of customers (i.e., the target audience) projected to desire the product or service. This requisite additional testing time to gather customer responses extends the business cycle required to make product improvements which in turn can significantly delay introduction into the marketplace. For example, U.S. Pat. No. 5,090,734, Dyer et al., issued Feb. 25, 1992, discloses a method where customers are shown product concepts in a series of cycles or “waves” that require the customer to make choices and select products for use in the home over a period of weeks. It can readily be appreciated that any method that can speed this business cycle of product development can result in a significant strategic advantage.

Due to the importance of concept acceptance for the success of a new product in the marketplace, there has been increasing interest in the development of models to predict an individual or group reaction to new products or services. As will be shown herein, the method of the present invention provides a very powerful system for evaluating reaction to concepts using analysis techniques previously unconsidered for application to problems of marketplace simulation.

The method of the present invention is a dramatically different approach in the field of customer research. In some cases the invention can replace customer research. Additionally, the method of the present invention can be used before customer research to determine which concepts are worthy of research. In both of these cases the one notable advantage is the rapid cycle times that the practice of the present inventive method affords. For example, a national survey found the average time investment is 17.2 weeks for approval and placement of new ideas into a new product/service idea development pipeline (Anderson Consulting 1997). The method of the present invention could allow this process to be completed in a matter of minutes or a few hours.

In the traditional art of market research techniques, actual customer response data is collected and this data is used with a variety of mathematical techniques to predict customer behavior. From a process standpoint, the customer was shown some form of stimulus and then asked questions concerning the stimulus and then conclusions were calculated that related these questions to the customer's actual response. Thus, there is a customer exposure requirement in order to make customer-based conclusions about variables related to the research questions posed. The only conclusions identified are between what questions say and the customer's response to those questions. In some cases factor analysis is used to identify “latent” variables via combinations of variables and responses to those variables but rarely are these latent variables operationalized and analyzed directly with the collection of new data for a second appraisal of the same concept.

The method of the present invention, in contrast, projects what a consumer response would be based on historical and archived accounts of consumer responses to past products and services (though the products and services were new at the time they were evaluated). The present invention utilizes a set of questions and measures that are inferred, known, or hypothesized to be the causal factors behind the past consumer responses and these factors are then applied in varying degrees to the current concept under review. The resulting relationships between the factors themselves for the archived concepts and the degree to which the factors (hereafter called archetypes) are present in the current concept are used to forecast conclusions concerning the likely business outcomes of new concepts that have not yet been exposed to customers. To summarize, the methods of market research used today are customer focused while the method of the present invention is concept focused.

Another aspect of the present invention is the development and use of the registered trademark Artificial Wisdom™ in connection with the present inventive method. The new concept focused process paradigm of the present invention is termed Artificial Wisdom™ as a means to relate the use of prior knowledge or conclusions drawn about a specific stimulus to the possible set of customer outcomes without the need to collect actual customer responses. Such an approach improves the intellectual capital value of corporate databases and the whole research process. In other words, “wisdom” is the ability to make good decisions in novel situations based on past experiences.

There are many advantages to using the present inventive method in place of prior art market research or market simulation techniques. For example, the present method allows for greatly increased speed of data collection and analysis. By using the method of the present invention, new ideas may be evaluated and forecasts created in a matter of minutes. The result is an ability to conduct tests and learn cycles much faster than traditional research methods that currently take anywhere from 1 week to 3 months or longer.

In addition to improved testing and learning cycles, the speed of the present process makes it possible to consider significantly greater numbers of ideas. Given that one study found it takes 3,000 raw ideas in order to develop one profitable success, this increase in speed of evaluation makes it possible to develop more profitable ideas per unit of time. See Stevens, A., & Burley, J. (1997). 3000 Raw Ideas=1 Commercial Success. Research and Technology Management, 40, 16-27.

Another advantage associated with the use of the present method is that the additional intelligence that can be derived from a set of collected customer data allows managers to identify and validate business judgements as well as to identify hard to articulate emotional, motivational and aspirational archetype drivers. Still another advantage of the present method is the significant cost savings realized upon removing the customer component from the testing process.

Another important advantage of the present invention is the dramatically enhanced security in the development of new products and services as compared with prior art techniques. This security is achieved because the proprietary concepts are evaluated without the necessity of exposing them to the public.

It should be appreciated that the inventive method of the present invention is not necessarily intended to replace traditional market research processes. Rather, the inventive method is designed to augment traditional processes by providing greater efficiency and an improved probability of success by acting as a “pre-customer filter” to judge a stimulus before the time, cost, and effort are expended in traditional new concept development and customer testing processes.

### SUMMARY OF THE INVENTION

The invention disclosed herein specifies a process for the simulation of customer reaction to concept stimulus. The method allows for the novel evaluation of a new concept, once the model is developed, without the necessity of time and expense to solicit customer reaction. More specifically, the method of this invention creates a model that simulates the accumulated consumer response to a wide variety of products and services both within and outside the concept product class and elucidates the determinates of the product or service idea that are predictive of future customer hedonic behavior. The model also has the utility of providing additional life to existing databases containing customer responses to stimulus.

The method of the present invention requires a number of steps (herein referred to as “frames”) that, when taken together, comprise the inventive method. The invention has utility for a wide variety of product and service classes (including non-traditional “consumer” communications, such as political and educational messages) that will be apparent to those skilled in the art of customer evaluation or prediction and the preferred embodiments and applications described herein are intended only to be illustrative of the inventive concept.

In the first step or frame of the present invention, a database of subjective customer responses is required. In the broadest sense, this database may be made up of any record of communication, by any means, put forth for judgement by another (i.e. customer). This database can be composed of similar or cross-category collections of product or service concepts. As used herein, “database” refers to a collection of customer information whether measured directly from customer given input or calculated or transformed from any method of inference.

The database may be obtained from prior research studies or may be developed specifically for use with the present invention. The development of such a database is well-known to those skilled in the art and can be derived from many sources. In general, it is preferred that the database have responses from representative customers to new products or services derived from a great number of stimuli. A stimulus is defined as any creation that relates to the item of interest that can be interacted with by a customer and from which a customer can give an opinion of or provide a judgment on. This would include Written concepts, story boards, verbal descriptions, visual graphics, a video commercial, a live demonstration, a sound recording, internet messages, print advertisements, live and audio/visual representations of a stage show, scripts for a theatrical or cinema production or any other construct that a customer response can be measured.

To provide subjective input data for inclusion in the database, a customer views stimulus and responds to a variety of questions specified on a predetermined quantitative scale, such as a 0 to 10 linear scale. Customer responses are collected from a plurality of questions that can take the form of rational or hedonic factors, such as likeability, interest, purchase potential, usage intentions, utility perceptions, level of confidence, interpretation, recall or expectation. The one requirement of the constructed database is that between each consumer's set of responses to a stimulus, there is at least one response variable in common. For example, as long as each consumer in the database had answered a question relating to “likelihood of purchase”, the database would be useful in the method of the present invention. The final database for use in this invention can be comprised of items from a variety of categories or classes without the need for specifying market similarity as long as at least the single common response factor is present.

There is no requirement that each item of stimulus be seen by the same or equal number of consumers. Each item or stimulus can be regarded as a data record in the final database. There is no requirement to complete or construct a new database if a suitable database already exists. This invention in preferred embodiments provides additional insight into currently existing databases.

In the second frame or step of the present invention, the database from the first frame is reviewed and a series of observable concept “archetypes” are generated from the stimuli contained therein. “Archetypes” are statements based on fundamental assertions regarding the stimulus with regard to consumer response; they are determinants which help predict consumer behavior. Archetypes can contain a rational archetype as well as an emotional archetype. In addition, archetypes can be relational elements that weigh dimensions such as the level of rational versus emotional communication, the impact of the use of an established brand trademark on the product's credibility or the advertising's executional image and production values impact on a political candidates credibility.

Archetypes generally quantify the existence or nonexistence of some event or claim. Archetypes, in other words, are the perceived, known, desired, hypothesized, doubted characteristics of the stimulus that are the basis for customer interaction with that stimulus. An archetype can be a representation of: customer perception, behavior, expert knowledge about, or any outcome proposed that could define the stimulus. In preferred embodiments, these archetypes are derived from comments made by the customers themselves. In other preferred embodiments, the archetypes are specified by the product developer who has specific characterizations of the stimulus under consideration. The archetypes created do not have to be related to all data records contained in the database. No conditions for relationship between the archetype and the data record need be assumed in the development of this frame. The selection of archetypes creates a plurality of ratable decision attributes that can be quantified. Examples of archetypes which may be useful include: definitions and variations of an overt customer benefit in the new product, real reasons to believe that the benefit actually exists in the new product; and dramatic differences, or a “uniqueness”, between the new product and conventional products. There is no specified limit on the number of archetypes that can be developed for a given stimulus database. In other words, the method has utility for any number of multiple attributes that can be practically assigned to the concepts useful to those skilled in the art.

For each archetype that is identified, a rule set is needed by which to convert the given form of a provided stimulus into quantifiable or numeric representations of the desired archetypes. This rule set can be utilized by either a human evaluator judging against a set of archetype criteria or by a machine measure of the archetype (i.e. the Flesch-Kincade readability scale). There is no requirement for which type of scale is specified other than that the scale be measurable and interpretable by one skilled in the art. Such scales could include the Likert scale (3, 5, 7 box), Juster (7, 9 or 11 point continuous scale), categorical (yes, no), or any continuous scale with anchored descriptors.

The third frame specifies the collection of data on the selected archetypes from the previous frame. In preferred embodiments, the archetypes are not scored by the customers who viewed the original stimulus. In many cases, these customers are no longer available for further interaction with the stimulus. In this case, the stimulus is rated by one or more raters where the rater judges the degree of the archetypes present in the individual concepts. When raters are used, the archetypes are scored or quantified according to predetermined rules. Those skilled in the art will be aware of evaluating rater performance for calibration, reliability and objectivity. The archetype database is then combined with the customer database to create a simulation model predicting how consumers would respond to the stimulus.

The fourth frame specifies the desired modeling approach to discover relationships between the archetypes and the consumer outcomes contained in the stimulus database. This step of deriving or modeling relationships between the archetypes and customer response may include any combination of standard univariate, bivariate, and multivariate statistical methods (e.g., cross-tabulations, t-tests, ANOVA, correlation, regression, factor analysis, structural equation modeling) in addition to more contemporary methods of prediction (e.g., artificial neural networks, genetic algorithms, and fuzzy logic and fuzzy control systems). In one embodiment, the model building approach is accomplished with a neural network to select those archetypes that best relate the customer responses to the concepts in the database. In other preferred embodiments, expert-based models such as rule-based or case-based reasoning are also used to elicit relationships between the customer responses and the specified archetypes. Those skilled in the use of neural networks or other statistical models will recognize the requirement for any derived model to account for goodness of fit or similar error measurement adequate for simulation accuracy.

It is preferable that the method of the present invention include a fifth frame where some judgment of potential relative success for a given concept is made. This judgement can be set by any criteria desired such as marketplace reality, personal expectation, or any other defined benchmark from which a decision can be made. The most common claim would be a system that delivers a forecast of a concept's success potential. It is also preferable that the method of the present invention include some action criteria for specifying remedy or resolution to interpret or react to the conclusions derived from the outcome's earlier frames. This could be as easy as evaluating 10 new concepts and then ranking them from best to worst and selecting the top three as passing the action standard to go on to customer research. In an iterative cycle process it could involve providing feedback on a collection of archetype vectors designed to provide guidance to concept developers on how to enhance tested concepts. Archetype vectors are a collection of archetypes mathematically assembled in order to assist in forecasting success potential or as a diagnostic feedback for enhancing a concept. For example, a low score on reason to believe might prompt a series of suggestions for increasing the reason to believe based on concepts from the source database that have a strong reason to believe.

In whatever form the action criteria takes, this step provides a feedback system to speed the development cycle time and make business-oriented decisions. The new concept stimulus can thus be evaluated and a consumer response predicted in a fraction of the time of a traditional customer concept test. This allows for substandard product concepts to be modified or optimized prior to marketplace introduction.

Although it is preferred that the frames or steps of the present invention take place substantially as outlined above, it should be appreciated that it is not a requirement that the steps be performed in this specific order. For example, after a model is built and new concepts are introduced and validated against the predicted results, archetypes may need to be added, changed, or deleted and the process may need to be repeated. Further, if an action taken based on suggestions from the model proves less than beneficial, the selection of concepts from the source database may need to be altered, the archetypes may need adjustment, and a new model may need to be built.

As will be appreciated, the present invention provides an advancement to the art that provides utility in dramatically speeding up the development cycle for a new product or service while providing a process to capture prior customer learning and apply it to other product or service categories.

### BRIEF DESCRIPTION OF THE DRAWING

While the specification concludes with claims particularly pointing out and distinctly claiming the present invention, it is believed that the same will be better understood from the following description taken in conjunction with the accompanying drawing in which:

FIG. 1 is a flow diagram depicting the sequence of steps in accordance with the method of simulating human response to stimulus of the present invention.

### DETAILED DESCRIPTION OF THE PREFERRED EMBODIMENT

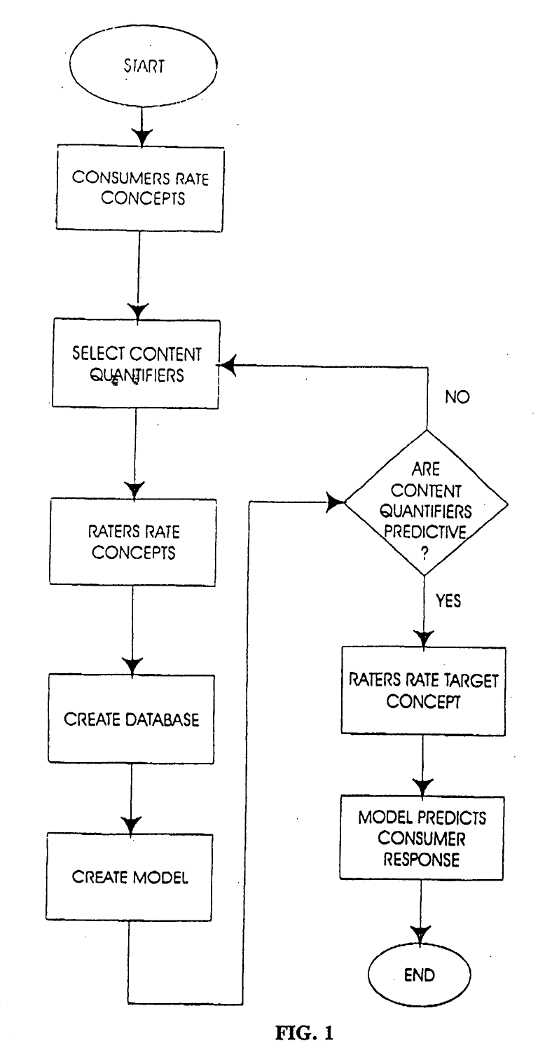

Reference will now be made in detail to the presently preferred embodiments of the invention, an example of which is illustrated in the accompanying drawing of FIG. 1. The present invention provides a method for simulating customer reaction to new or “target” products, services, or concepts to be evaluated prior to exposing the stimulus to the customer.

This invention has specific utility for providing information on the underlying determinants that relate to hedonic customer response and relating them to a variety of products across product classes. The additional utility of the method described in these “frames” relates to a process that effectively captures and uses the product “wisdom” as revealed by historical customer reactions to products.

The present invention can be used to predict an individual or group reaction to a wide variety of concepts. As used herein, the term “concept” is one form of stimuli and is intended to refer to any tangible or intangible entity or item for which it is desired to determine or predict a consumer reaction thereto. For example, concepts can include products such as foods and beverages, paper products, health and beauty aids, pharmaceutical products, laundry and cleaning products, cosmetics, books, movies, sound recordings and any other consumer, retail or tangible and intangible product. Concepts can also be services, such as financial services, real estate services, legal services and any other consumer, retail or any other tangible or intangible service.

Information about a concept, such as a product or service, can be communicated to an individual through the use of “communicable information”. As used herein, the phrase “communicable information” is intended to refer to any information about a concept which may be communicated to and perceived by an individual or machine. Communicable information is thus perceived by using any one of the five senses (e.g., sight, hearing, touch, smell and taste) or in the case of machines one might capture “communicable information” with scanners (e.g., colors, contrast, brightness, pattern recognition) and with programmed analysis of text (e.g., readability index, grammar and spell checking) and sound (i.e., voice recognition). Moreover, communicable information might include photographs, audiovisual information, tactile, or olfactory stimulus. Typically, however, information about a concept is conveyed to an individual by an advertisement for the concept which might contain a picture as well as a textual description (e.g., price, attributes, etc.) of the concept. Thus, the communicable information represents the cumulative message about a concept which is conveyed to an individual and it may be conveyed using a plurality of mechanisms.

The initial frame of the invention requires a database of customer responses to questions or subjective “reaction quantifiers” pertaining to “source concepts” or those products or services currently offered or proposed for offering in the marketplace. The present invention is designed to provide extended value to previously collected consumer data. Oftentimes, after such subjective consumer reaction data is collected, it is only used for interpretation of the consumer marketplace directly applicable to that product. In contrast, embodiments of this invention preferably use large collections of existing consumer data containing a large numbers of products for predictive simulation. In one application of the present invention, a set of approximately 4,000 product and service concepts from a broad range of product classes was used to develop a simulation model by the method described herein. In another, a simulation model was developed from 100 concepts from a specific product category. Further, for use with the present invention, all concepts in the database should have at least one common response variable used to measure subjective consumer reaction to concepts. For example, each concept used in the database should have a common subjective response variable, such as a “purchase interest” score which is derived from questions like “would you buy this?” or “do you like this?” Other response variables might be, for example, desire to try, interest in watching, would like to try, actual ticket sales of past movies or theatrical shows, previous vote percentages for political candidates, television show ratings, advertising persuasion, advertising recall, customer satisfaction, would recommend to a friend or any number of other customer interaction with the stimulus. This common customer response can be any desired attribute for which future market simulations are desired.

A user of the inventive method could arrive at the one common response factor with a variety of techniques. That is, the common measure can be created as part of a standardization or translation technique that takes two or more response variables from separate and distinct databases and combines them into a new common measure. For example, a common measure could be created by using percentiles where the distribution of the two variables from separate databases are each cut into 100 equal frequency groupings (i.e., cut points). Thus, both variables will have similar scales and the individual values are comparable according to their respective percentile rankings.

Once the database is collected, the next step (frame two) is selecting the set of descriptors (archetypes) that can be used to convert a text and/or visual input into a mathematical input. This transformation is accomplished via a case-by-case evaluation of various attributes and archetypes present in each concept. For example, an archetype could be the interpretation of a “communicated product benefit” (i.e., how strongly is the product benefit conveyed?). After an archetype is identified, it is scaled and endpoints are defined. In one embodiment of this invention, a large set of archetypes have already been pre-selected and incorporated into a computer interface. The user selects which of these archetypes will be used in a particular study and then builds an automated model based on that selection.

The collection of archetypes can either be user defined or empirically formulated. There are virtually an infinite number of possible archetypes. The choice of archetypes, however, is controlled by their predictive value. For example, “phase of the moon” is a possible archetype, but it probably has little predictive value in a market simulation problem involving the purchase of a new car. Thus, the archetypes selected are generally ones that intuitively feel connected to the particular market problem being studied. Of equal importance is the description and interpretation of each specified archetype. For example, a customer benefit may be described as those benefits that provide for the wants and needs of the customer. Stated differently, a product exhibiting a benefit is one that answers the question of what the product will do to improve, enhance, or change the quality of life of the consumer. An additional archetype that has proven useful is “a reason to believe” that the product will deliver the benefit it promises. Because credibility is a large weakness with most concepts, this archetype is important in measuring how well a consumer perceives that the benefit will actually be delivered. Another useful archetype is the degree to which a new product or service exhibits a “difference” or uniqueness from what currently exists or is available in the marketplace.

Providing clear definitions of archetypes is necessary to assure that multiple raters of a given concept maintain a level of consistency during the rating process (frame three). There is no requirement for how many raters objectively evaluate a concept, but those that do need to be evaluating from the same numerical boundaries. A rater is defined as an individual who objectively rates a concept using the guidelines specified for each archetype descriptor. When multiple raters evaluate a concept, rater agreement (consistency) for identical concepts needs to be determined prior to model building. Rater agreement determination can be built into the simulation prior to model development as a control for proper data conditioning and for proper attribute calibration. Rule sets are also used to convert the stimulus into numeric representations of the desired archetypes. Rule sets can be applied by either human evaluators or by automated machine measurement of the archetype.

At the completion of concept transformation from visual and/or text to numerical form, the next step of the present method (frame four) is to pass the entire data set into a model building system. This model building system may be a simple matrix that uses percentage differences from a cross tabulation of the archetypes at high, medium, and low values against the value of the response variable, an Ordinary Least Squares (OLS) regression model, a fuzzy logic model, and/or a neural network model. Combinations of techniques are possible and likely.

The method of the present invention also has application with respect to assigning retailer slotting fees. For example, in any given year, it is not uncommon for 10,000 or more new products to be introduced in the retail grocery industry. In order to mitigate losses associated with stocking new and unproven products, retail grocers frequently charge wholesalers “slotting fees” to display new products in their stores. Because of the uncertainty surrounding the likelihood of success of any given new product, retail grocers typically charge the same or similar slotting fees for similar items.

The method of the present invention may be used in this situation to provide an independent judgment of the probability of success of any given new product as described in detail previously. A retail grocery corporation may use the probability of success of a given new product to assign an appropriate slotting fee corresponding to the associated risk of the new product being unsuccessful. For example, a new product with a high likelihood of success would be charged a relatively lower slotting fee. Similarly, a product with an average likelihood of success would have an average slotting fee. A risky product with a low chance of success could be charged a high slotting fee. The method of the present invention, accordingly, provides a more objective means for a retailer to mitigate risk associated with new product failure. Not only would this have an application in the retail grocery industry, but essentially any retail (or other) industry where a wholesaler, broker, or other “middle man” sells new products for resale by retailers.

Another potential area of application of the method of the present invention is in the legal system. For example, a database may be generated containing historical juror reactions to prior courtroom activities. Such a database may contain information relative to juror responses to certain language, legal defenses, attorney style of delivery, or essentially any stimulus to which a juror may be exposed in a courtroom setting. The method of the present invention would allow lawyers to gauge the probability of a juror viewing a certain courtroom procedure or stimulus as favorable (i.e. more likely for a juror to acquit or find not liable) or unfavorable (i.e. more likely for a juror to find guilty or liable).

As mentioned previously, and in accordance with an important aspect of the present invention, it should be appreciated that the various steps of the inventive method need not be performed in a particular order to achieve useful results. Depending on the situation, it may be necessary to perform the steps of the invention is a different order as compared with other applications of the invention. For example, in most any corporate setting, it is not uncommon for certain “corporate rules of thumb” to evolve into part of the established collective corporate wisdom and way of thinking. These rules of thumb may develop over time or may be caused by some exceptional event rather suddenly to become part of the collective corporate wisdom. The method of the present invention is useful for testing and validating such components of corporate wisdom.

To illustrate, by interviewing executives, or other personnel of a company, an archetype may first be identified that corresponds with such a component of corporate wisdom. Next, a historical customer response database as described in detail above may be used in a “reverse” fashion to identify historical customer responses to the particular archetype or corporate wisdom component in question. Next a model may be developed and tested that relates the corporate wisdom archetype with the actual historical customer responses in the database. In such a manner, the established item of corporate wisdom may be either “validated” if it is confirmed to correspond to historically favorable customer reaction or “invalidated” if no such correspondence is found.

### EXAMPLES OF THE INVENTION

The following examples show how the inventive method of the present invention may be used to make judgments about a stimulus without the requirement of customer responses. The examples discussed are illustrative and are not meant in any way to be restrictive to the scope of the potential application of the invention.

### Example 1

### A Simple Artificial Wisdom System Based on Cross Tabulations

In this example a set of 1000 concepts from the food, health and beauty, and services were collected into a database. All of these concepts had been tested with a nationally representative set of customers screened as users of these products. The entire database had the same response for “purchase interest” recorded on the same 0 to 10 luster purchase probability scale. Three archetypes that serve as indicators of customer purchase motivation were created for this data set. These archetypes were defined as (1) Does the concept contain a benefit? (2) Does the concept contain a reason to believe? (3) Is the concept new and different?

The three archetypes were rated on a 0 to 10 luster scale with labeled end points at both ends of the scale. All 1000 concepts were rated by a judge on all three archetypes. The data were then collapsed into tertiles representing a high, medium, or low presence of each archetype (labeled as 3, 2, and 1 respectively) for each concept and the purchase interest value was collapsed into high and low category values for each concept. The archetypes for each concept in the database were then cross tabulated with the customer purchase interest score to find trends of archetype contribution to high purchase interest. Recall that the customer purchase interest data was rated on a 0 to 10 Juster and based on previous experience a value of 7 and above was deemed to be a “winning” concept.

A simple 3×3×3 matrix was constructed to evaluate the percentage of winning concepts for each of the archetype combinations. For example, the percentage of winners in the database that are included in the Low Benefit, Low Reason To Believe, and Low New and Different combination (i.e., 1,1,1) was 12.5%. Therefore a new concept that has not yet been tested with customers, but had been judged to be in the same archetypal space, has a 12.5% chance of being a “winning,” concept when tested with a nationally representative set of customers. A representative table of sample archetype combinations to predict % winners follows for this example is shown in Table 1.

TABLE 1
Combinations of Strategic Attributes - Example 1

| Benefit | RTB | New & Different | % Winners |
|---|---|---|---|
| 1 | 1 | 1 | 12.5 |
| 1 | 1 | 2 | 18.4 |
| 1 | 1 | 3 | 39.3 |
| 2 | 2 | 1 | 15.2 |
| 2 | 2 | 2 | 39.9 |
| 2 | 2 | 3 | 52.8 |

### Example 2

### Using the Steps in a Different Order to Identify Wisdom

One way to leverage the internal intellectual capital of an organization and use it to drive concepts into the product/service development pipeline at a faster rate is to use the various steps (and thus the frames) of the inventive method in a different order. As will be shown in this example, it is an important feature of the method of the present invention that the various steps may be accomplished in different orders.

The objective of this example is to demonstrate the value of capturing corporate knowledge. In other words, use of the present inventive method allows a corporation or other group to gain knowledge and discover principles while building a core set of benefits that customers respond to. The ultimate goal was to create a set of guiding principles that would greatly enhance the number of successful ideas created and moved through the corporate system to the marketplace.

In this case, the first step was to start with the development of a collection of broad archetypes that were generated from principles taken from a series of one-on-one interviews with corporate executives, academic leaders, and marketing managers. This resulted in a set of 23 “rules of thumb” or “core” archetypes considered to be truths for the category. The second step in this example was to create a unique data set with the objective of discovering the best archetypes that capture customer behavior. To do this a series of 200 concepts were selected that included various combinations of archetypes with varying levels of contribution.

For the second and third steps of this example, it was anticipated that these steps would undergo numerous iterative cycles before proceeding. To illustrate this iterative process a subset of 100 concepts were chosen at random from a set of 3,948 concepts to speed archetype discovery and development cycle times. In the first cycle, approximately 50 archetypal dimensions were tested with the 100 concepts. Two highly trained auditors evaluated the 100 concepts. In this example the collection of concepts with a common measure for customer purchase interest was already available.

For the fourth step of this example, determining the set of archetypes that would describe the database, a bivariate correlation matrix and an OLS regression analysis were used to determine the set of archetypes predictive of purchase intent. These archetypes were then combined into a smaller group of measures to reach the most parsimonious group of archetype measures predictive of purchase intent. For the fifth step of this example, archetype vectors (i.e., groups of archetypes) were then assembled using summations of raw archetype values to provide diagnostic feedback systems (conceptually similar archetypes were grouped together) and enhanced predictive power.

The important improvement in wisdom that was exhibited in this example was not the number of archetypes developed but the unexpected finding that some of the “core” archetypes developed from corporate conventional wisdom were found to have no impact or to be inversely related to true customer response. This demonstrates the model's ability to provide a more accurate wisdom basis for making concept, product, service, or advertising development decisions.

The final step of the present example was to utilize the model with business leaders to determine if the results of the model provided enough substance and value for them to take action based on the results. In numerous cases, the model was found by clients to be a valuable tool for rank ordering a collection of ideas and as an aid in setting development priorities. The model was also found as a valuable tool for executing sequential test and learn cycles to enhance previously tested concepts that hadn't scored well in consumer testing. Thus, there was a savings in time, money, and new R&D.

### Example 3

### Building an Artificial Wisdom™ System Containing Strategic and Tactical Lessons and Laws

In this example, a set of 3,948 new product and service concepts were gathered from a library of archived concepts from a wide range of market categories such as: food, technology, automotive, health, and beauty, telecommunications, health care, and financial services. Each concept was presented to a random sample of approximately 100 potential customers. In this example concepts consisted of a description of a product or service as it exists or might exist. A concept may have included any or all of the following: artwork that depicts the product or service being used, a graphical rendition of the item's packaging, a name, a one sentence summary or “tag line” encapsulating the key benefit, and more detailed text that describes the product or service and promotes the features to a customer. In some cases, the concept could be the actual commercial print advertising used to market a particular product of service.

Customers indicated their likelihood of purchasing the items represented by each concept by choosing from a range of numerical values starting with zero and ending with ten. Endpoints of this scale began with “definitely would not purchase” (e.g. a value of 0) and “definitely would purchase” (e.g. a value of 10). Also measured was the consumer's perception of how new and different or unique the concept is compared to products or services available in the marketplace. Endpoints on this scale began with “not very new and different” (e.g. a value of 0) and “very new and different” (e.g. a value of 10). A mean value from the sample of consumer responses on the two measures was created for each concept.

A review of the literature and a content analysis of the concepts facilitated the identification of 35 dimensions hypothesized to be important to consumer reactions. Archetypes encompassed a wide range of factors such as benefit, credibility, uniqueness, tone, and character. All concepts were then evaluated on these 35 dimensions by a group of trained raters. During evaluation, the rater examines a concept by looking at the artwork, reading of the written copy, dissecting and diagramming the concept into its archetype components (e.g. benefit, credibility, uniqueness), and then rating how well the concept performs on each of the 35 dimensions by using a zero to ten scale for each the archetype dimensions, hi some cases, however, the archetype is evaluated using a categorical rather than a scalar 0-10 response set (i.e. 1=product concept, 2=service concept).

It will be apparent to those skilled in the art that the raters must do an accurate job at measuring each concept on the archetypal dimensions. Thus, the use of rater reliability measures and calibration procedures are required to achieve a useful archetype response set.

In one case an archetype was not evaluated by a human rater, but rather, the written text from the concept was evaluated by a computer algorithm (i.e. machine rating of the archetype present in a concept). Specifically, an archetype called the readability index which uses the Flesch-Kincaid Grade Level was used and the formula includes measures such as syllables per word and words per sentence.

A standard ordinary least squares (OLS) regression method was then used to evaluate each of the 35 archetypes ability to predict purchase interest and uniqueness. From this regression analysis a model containing 12 archetypal variables was found to be adequately predictive of customer purchase interest. This OLS model can now be used to predict customer purchase interest scores for new concepts by having the new concepts rated according to the same archetype set used to build the model from source concepts.

In other embodiments, the predicted customer purchase interest scores are reported as quintiles that are formed by translating the original customer purchase intent database into five equal groupings and identifying the ranges of purchase intent values falling within each of the five quintiles. Each quintile is labeled with a “star” rating (e.g. 5 stars=excellent concept, 4 stars=good concept, 3 stars=fair concept, 2 stars=below average concept, and 1 star=poor concept). The predicted purchase intent value for a target concept is given the appropriate number of stars with respect to the quintile range the value falls within from the original source database. In other embodiments a 100 percentile scoring system can be used where the original response variable in the customer database is put into 100 equal groups and the predicted purchase interest value is reported as a benchmark (e.g. the new concept predicts a purchase interest value falling in the 85^{th} percentile compared to all other concepts in the database.)

The OLS regression model can easily provide values of archetype contribution to the final predicted purchase interest score. These archetype contributions or coefficient values to those skilled in the art can also be reported in the same “star” ranking as described above. In this way, specific archetypes can be used to provide corrective or “prescriptive” advice for improvement or selection of a particular concept. These specific archetypes can be reported as “laws” that help impart strategic wisdom to the developer of the tested concept in terms of current concept strengths and areas of weakness that need improvement.

For example, if the archetype for “concept contains a benefit” receives a 5 star rating, then this concept can be said to contain a strong benefit message. Another important action standard can come from combined archetype measures in the form of “lessons.” These lessons can be interpreted as tactical or executional guidelines for concept improvement. For example, “Strategic Clarity” can be defined as a higher order archetype that tactically defines how clear the idea is conveyed in the concept. Clarity along with simplicity, clearness, and understandability are important towards proper communication of the idea and reduces the chance of being misunderstood. Clarity matters because the customer must first correctly understand and know what the product or service is before they can begin to formulate any judgments about it. That is, the more clear the communication of the idea and its respective components (e.g. benefit, reason to believe, uniqueness) the more likely the idea will be interpreted as intended. Strategic clarity is composed in this case as an archetype vector from three separate archetypes for benefit, reason to believe, and new and different. The specific archetype used in the concept for benefit was “the primary benefit is clear and easy to identify and explain in a simple sentence.” The diagnostic use of a lesson like strategic clarity can be reported back to the developer of the concept as a direction for concept improvement.

### Example 4

### Using a Neural Network to Build a Multi-Archetype Model to Predict Customer Purchase Interest of New Product and Service Concepts

An artificial neural network is the name given to a generalized class of mathematical models that are structurally analogous to the processing unit of biological neurons. Neural networks are widely used in predicting future outcomes from input data sets in such fields as control engineering, formulation optimization, biological system modeling, stock market trading, credit risk assessment, and speech or object recognition. In this example, the model development frame advantageously uses a computer-implemented neural network to select the desired archetype predictors for consumer response predictions.

The neural network used in this preferred embodiment is defined as a feedforward architecture using an adaptive gradient descent-learning algorithm with hyperbolic arc tangent transfer functions. Other architectures also may be used. The choice of neural net architecture is dependent upon the structure of the data utilized, the amount of noise or error in the data signal, and the objective of the desired outcomes. A neural net, in general, builds a model based on reference data and neural network modeling approach is applicable in most any situation where there is an unknown relationship between a set of input factors and there are known outcomes. The objective of model building is to find a formula or program that facilitates predicting the outcome from the input factors.

The primary activity in the development of a specified neural network for prediction is to determine values for the weights that optimize the relationship between information provided to the input layer that passes through to the output unit. The process of determining the values of the weights is referred to as “learning.” The process of learning is divided into two activities; training and validation.

There are many ways to accomplish learning in a feedforward neural network. The most widely used learning paradigm revolves around various adaptations to a generalized calculus-based technique known as back-propagation. Back-propagation is a technique for adjusting the weights starting from the outputs back to the processing layer and then repeated back to the input layer in an attempt to minimize the error based on a specified criteria. Back-propagation assumes that all processing elements and connection weights are responsible for some level of the error and adjusts the weights backwards through the model without bias to the updating of connection weights. The choice of the error function is again left to those skilled in the art. In the present example, a version of back-propagation called gradient descent was used in which each unit in the processing layer had a single error value associated with it.

In training, a subset of the total database is selected to establish weights for the connection using a known set of outputs for which the transfer function scans relative to the known inputs. Once the weights have been optimized via back-propagation in the training set, the corresponding model can be used to establish fit to the remaining data set through validation. Validation requires that the remaining data set inputs be passed through the processing units keeping the connection weights constant and comparing the values of the calculated outputs to the known outputs present in the data set. The goodness-of-fit for a particular model can be chosen as desired for applicability of the calculated values from the model to the actual values before further predictions are made. A simple goodness-of-fit assumption would specify a given value of correlations such as a Pearsons correlation coefficient between the calculated outputs and the true outputs in the database as a criteria of determining a successful model.

There are many strategies for selecting the subset of data from the database that is used in training. The procedural details are left to those skilled in the art and can include, for example, taking a set percentage of the data either randomly or in sequence and a certain selection strategy might be used where a collection of points that represent extreme values in the data set are augmented with a certain number of randomly chosen data points. In this example the choice of a training set was selected as a set number of points that represented a uniform distribution of the values found in the output unit.

The unique aspect of a neural network that makes it so valuable as a class of prediction models is that in the process of training the connection weights are not fixed but are allowed to change as the learning paradigm adjusts the weights in an attempt to minimize the error function. The initial value of the weights are generally randomly selected in some specified range and the initial outputs calculated from the inputs are passed through the transfer functions in the processing layer. In back-propagation, it is not the absolute value of the error that adjusts the weights between connections but rather the derivative of the weights with respect to the value of the activation function within each respective processing unit. Thus, a network is said to “learn” from the given set of training inputs for which connection weights are determined in an iterative fashion until the minimized error function is satisfied.

The state of the neural network can be viewed at any time as a matrix of vectors that present the contribution of the various inputs on the outputs via the weights. This allows for the selection of inputs or archetypes that best define the output response. When the model has completed learning as specified by the minimization of the error function, inspection of the weights within the network reveals elements for those archetypes that best describe the output. This can lead to a subset of archetypes for which further concepts can be rated upon and output estimates can be calculated as consumer predictions.

In this example, 100 concepts were selected that represented a uniform distribution of consumer purchase interest values across the response range. The values for the rated archetypes were used to create the input layer and a group of 36 inputs were used to build the feedforward network. Cascade correlation was used to add hidden processing units one at a time to the network. Each new hidden unit is used to predict the current remaining output error in the network and proceeds until a minimum error is achieved. The final neural net model architecture contained 24 input archetypes, 15 processing units in a single hidden layer, and one output unit. This became the model that is used in Frame 5 for concept prediction of consumer or customer response to a target concept.

In Frame 5, a validation set of 500 randomly chosen concepts, unseen and unanalyzed during model development, was used as a validation to the model developed by holding the connection weights constant in the model and passing the input data through the network to produce a set of estimated output values. This model was sufficient for use in simulation of consumer response to new concepts. The output for use in judging concept success was again based on specified criteria of success and is dependent on the model objective. In this context, the consumer purchase interest was encoded on a 0 to 10 modified Juster scale and the outputs simulated on this same scale.

From the original concept database, criteria for specifying a successful new product idea were determined as those in the top 20% of customer purchase interest. Thus, in this embodiment, those concepts from the original database with as score greater than 6.5 on the 10 point scales were labeled as “green light.” Those from 4 to 6.5 were specified as “yellow light”, and below 4 was “red light.” Therefore, any new product concepts that were rated on the archetypes, scored, and passed through the model to yield a “green light” rating were selected as appealing concepts to future customers. To validate the described model, a series of 18 concepts for new food products were simulated and found to contain 14 green, 1 yellow and 3 red light concepts. These 18 concepts were then shown to a representative sampling of customers who were asked to rate likely purchase interest in these new food product concepts. The customers matched 83% of the concepts to the modeled simulation of the same response of purchase interest.

Having shown and described the preferred embodiments of the present invention, further adaptation of the method for predicting a response to a stimulus can be accomplished by appropriate modifications by one of ordinary skill in the art without departing from the scope of the present invention. A number of alternatives and modifications have been described herein and others will be apparent to those skilled in the art. Accordingly, the scope of the present invention should be considered in terms of the following claims and is understood not to be limited to the details of the structures and methods shown and described in the specification and drawing.

What is claimed is:

1. A method for predicting reaction to a target concept, said method comprising the steps of:
(a) providing a database comprising subjective reaction data, said subjective reaction data comprising responses of a plurality of individuals to at least one subjective reaction quantifier capable of being used to subjectively evaluate communicable information about one or more source concepts upon exposure of at least some of said one or more source concepts to at least some individuals of said plurality of individuals, said database further comprising responses to at least one common subjective reaction quantifier for a plurality of said one or more source concepts;
(b) selecting one or more archetypes adapted to assist with the objective evaluation of the content of the communicable information of at least some of said one or more source concepts;
(c) generating objective ratings or rule sets of at least some of said source concepts in said database based on one or more of said archetypes;
(d) developing a model defining the relationships between at least some of said subjective reaction data and at least some of said archetypes;
(e) generating objective ratings of said target concept in accordance with one or more of said archetypes defined by said model; and
(f) inputting said objective ratings of said target concept into said model to predict a predetermined population's subjective reactions to said target concept.

2. The method of claim 1, wherein said at least one common subjective reaction quantifier is adapted to elicit responses related to consumer likeability.

3. The method of claim 1, wherein said at least one common subjective reaction quantifier is adapted to elicit responses related to consumer interest.

4. The method of claim 1, wherein said at least one common subjective reaction quantifier is adapted to elicit responses related to consumer purchase potential.

5. The method of claim 1, wherein said at least one common subjective reaction quantifier is adapted to elicit responses related to consumer perceptions.

6. The method of claim 1, wherein said at least one common subjective reaction quantifier is adapted to elicit responses related to consumer confidence.

7. The method of claim 1, wherein said at least one common subjective reaction quantifier is adapted to elicit responses related to consumer recall.

8. The method of claim 1, wherein said at least one common subjective reaction quantifier is adapted to elicit responses related to consumer expectation.

9. The method of claim 1, wherein said at least one common subjective reaction quantifier is adapted to elicit responses related to consumer likelihood to purchase tickets.

10. The method of claim 1, wherein said at least one common subjective reaction quantifier is adapted to elicit responses related to voter response to political candidates.

11. The method of claim 1, further comprising the following step after step (b):
(b1) selecting a quantifiable scale for each archetype after said step (b).

12. The method of claim 11, wherein said quantifiable scale is selected from the group consisting of a Likert scale, a Juster scale, a categorical scale, and a continuous scale with anchored descriptors.

13. The method of claim 1, wherein said model is generated using standard univariate, bivariate, and multivariate statistical methods.

14. The method of claim 1, wherein said model is generated using a neural network.

15. The method of claim 1, wherein said model is generated using fuzzy logic.

16. The method of claim 1, wherein said model is generated using genetic algorithms.

17. The method of claim 1, wherein said model is generated using cross tabulations.

18. The method of claim 1, wherein said model is generated using t-tests.

19. The method of claim 1, wherein said model is generated using ANOVA.

20. The method of claim 1, wherein said model is generated using correlation matrix.

21. The method of claim 1, wherein said model is generated using regression.

22. The method of claim 1, wherein said model is generated using Factor Analysis.

23. The method of claim 1, wherein said model is generated using Structural Equation Modeling.

24. The method of claim 1, further comprising the following step after step (d):
(d1) using said model to assist with the selection of archetypes required for evaluation of said target concept.

25. The method of claim 24, further comprising the following step after step (d1):
(d2) testing said model for assumptions of error and fit; and repeating steps (b)-(d2) as necessary.

26. The method of claim 1, wherein said source concepts are all from substantially the same product class.

27. The method of claim 1, wherein at least some of said source concepts are from substantially distinct product classes.

28. The method of claim 27, wherein said target concept is from substantially the same product class as said source products.

29. The method of claim 1 wherein said one or more archetypes comprise an “overt benefit” to a consumer or customer.

30. The method of claim 1, wherein said one or more archetypes comprise a “real reason to believe” of a consumer or customer that said target concept will provide a benefit.

31. The method of claim 1, wherein said one or more archetypes comprise the extent to which said target concept represents a unique or “dramatic difference” from currently existing concepts.

32. The method of claim 1, further comprising the following step after step (f):
(g) judging the relative potential success of said target concept.

33. The method of claim 20, further comprising the following step after step (g):
(h) developing and applying action criteria based on said archetypes and the relative potential success of said target concept.

34. The method of claim 1, wherein said database of said subjective reaction data comprises data from similar product or service concepts.

35. The method of claim 1, wherein said database of said subjective reaction data comprises data from dissimilar or cross-category product or service concepts.

36. The method of claim 1, wherein said step (a) further comprises the following step:
(a1) creating said common subjective reaction quantifier by normalizing and standardizing two or more separate and distinct databases containing subjective consumer response data and archetype data.

37. The method of claim 1, wherein said step (c) is accomplished by a human evaluator judging against a set of archetype criteria.

38. The method of claim 1, wherein said step (c) is accomplished by machine measure judging against a set of archetype criteria.

39. The method of claim 1, wherein said step (e) is accomplished by a human evaluator judging against a set of archetype criteria.

40. The method of claim 1, wherein said step (e) is accomplished by machine measure judging against a set of archetype criteria.

41. The method of claim 1 further comprising the following step:
(i) providing guidance to developers of said target concept on how to enhance or improve said target concept.

42. A method for predicting reaction to a target concept, said method comprising the steps of:
(a) providing a database comprising subjective reaction data, said subjective reaction data comprising responses of a plurality of individuals to at least one subjective reaction quantifier capable of being used to subjectively evaluate communicable information about one or more source concepts upon exposure of at least some of said one or more source concepts to at least some individuals of said plurality of individuals, said database further comprising responses to at least one common subjective reaction quantifier for a plurality of said one or more source concepts;
(b) selecting one or more archetypes adapted to assist with the objective evaluation of the content of the communicable information of at least some of said one or more source concepts;
(c) generating objective ratings or rule sets of at least some of said source concepts in said database based on one or more of said archetypes;
(d) developing a model defining the relationships between at least some of said subjective reaction data and at least some of said archetypes;
(e) generating objective ratings of said target concept in accordance with one or more of said archetypes defined by said model;
(f) inputting said objective ratings of said target concept into said model to predict a predetermined population's subjective reactions to said target concept;
(g) judging the relative potential success of said target concept;
(h) developing and applying action criteria based on said relative potential success of said target concept; and
(i) providing guidance to developers of said target concept on how to enhance or improve said target concept.

43. The method of claim 42, wherein said step (a) further comprises the following step:
(a1) creating said common subjective reaction quantifier by correlating and standardizing two or more separate and distinct databases of subjective reaction data.

44. The method of claim 43, further comprising the following step after step (b):
(b1) selecting a quantifiable scale for each archetype after said step (b).

45. The method of claim 44, wherein said quantifiable scale is selected from the group consisting of a Likert scale, a Juster scale, a categorical scale, and a continuous scale with anchored descriptors.

46. The method of claim 42, further comprising the following step after step (d):
(d1) using said model to assist with the selection of archetypes required for evaluation of said target concept.

47. The method of claim 46, further comprising the following step after step (d1):
(d2) testing said model for assumptions of error and fit; and repeating steps (b)-(d2) as necessary.

48. The method of claim 42, wherein said source concepts are all from substantially the same product class.

49. The method of claim 42, wherein said step (c) is accomplished by a human evaluator judging against a set of archetype criteria.

50. The method of claim 42, wherein said step (c) is accomplished by machine measure judging against a set of archetype criteria.

51. The method of claim 42, wherein said step (e) is accomplished by a human evaluator judging against a set of archetype criteria.

52. The method of claim 42, wherein said step (e) is accomplished by a machine measure judging against a set of archetype criteria.

53. A method for determining and assigning slotting fees for new product placement in a retail setting, said method comprising the steps of:
(a) providing a database comprising subjective reaction data, said subjective reaction data comprising responses of a plurality of individuals to at least one subjective reaction quantifier capable of being used to subjectively evaluate communicable information about one or more source concepts upon exposure of at least some of said one or more source concepts to at least some individuals of said plurality of individuals, said database further comprising responses to at least one common subjective reaction quantifier for a plurality of said one or more source concepts;
(b) selecting one or more archetypes adapted to assist with the objective evaluation of the content of the communicable information of at least some of said one or more source concepts;
(c) generating objective ratings or rule sets of at least some of said source concepts in said database based on one or more of said archetypes;
(d) developing a model defining the relationships between at least some of said subjective reaction data and at least some of said archetypes;
(e) generating objective ratings of said target concept in accordance with one or more of said archetypes defined by said model;
(f) inputting said objective ratings of said target concept into said model to predict a predetermined population's subjective reactions to said target concept;
(g) judging the relative potential success of said target concept; and
(h) assigning an appropriate slotting fee to said target concept corresponding to and based upon said relative potential success of said target concept.

54. A method for validating and testing an organizational cultural rule, said method comprising the steps of:
(a) identifying said organizational cultural rule and characteristics of said organizational cultural rule;
(b) providing a database comprising subjective reaction data, said subjective reaction data comprising responses of a plurality of individuals to at least one subjective reaction quantifier capable of being used to subjectively evaluate communicable information about one or more source concepts upon exposure of at least some of said one or more source concepts to at least some individuals of said plurality of individuals, said database further comprising responses to at least one common subjective reaction quantifier for a plurality of said one or more source concepts;
(c) generating objective ratings or rule sets of at least some of said source concepts in said database based on characteristics of said organizational cultural rule;
(d) developing a model defining the relationships between at least some of said subjective reaction data and characteristics of said organizational cultural rule; and
(e) using said model to evaluate the validity of said organizational cultural rule.
